(19) United States
(12) Patent Application Publication
(10) Pub. No.: US 2021/0023512 A1
(43) Pub. Date: Jan. 28, 2021

(54) GAS ENTRAINMENT SYSTEM FOR BEVERAGES

(71) Applicant: 3M INNOVATIVE PROPERTIES COMPANY, St. Paul, MN (US)

(72) Inventors: John H. Horns, Edina, MN (US); Joel Cardona, Charlotte, NC (US); Charlotte M. Starnes, Waxhaw, NC (US); Gareth P. Taylor, Indian Trail, NC (US)

(21) Appl. No.: 16/962,285

(22) PCT Filed: Apr. 5, 2019
(86) PCT No.: PCT/US2019/025973

§ 371 Date: Jul. 15, 2020

Related U.S. Application Data
(60) Provisional application No. 62/653,239, filed on Apr. 5, 2018.

(51) Int. Cl. B01F 3/04; A23L 2/54; B01F 15/00; B01F 15/02

(52) U.S. Cl. CPC B01F 3/04808; A23L 2/54; B01F 15/00357; B01F 15/00155; B01F 2215/044; A23V 2002/00; B01F 2003/049; B01F 2215/0022; B01F 2215/0468; B01F 15/0261

(57) ABSTRACT

A system for adding a gas to a liquid including a gas over liquid accumulator having an interior volume with a headspace, a liquid level, an accumulator liquid inlet, an accumulator gas inlet, and an accumulator gas outlet connected to the headspace. A contactor having a contactor gas inlet and a contactor gas outlet and a first supply of gas connected to the accumulator gas inlet. A second supply of gas connected to the contactor gas inlet and a supply of liquid connected to the accumulator liquid inlet. A first valve disposed between the first supply of gas and the accumulator gas inlet, a second valve connected to the accumulator gas outlet, a third valve disposed between the supply of liquid and the accumulator liquid inlet, a fourth valve disposed between the contactor gas inlet and the second supply of gas; and a fifth valve connected to the contactor gas outlet.

### BACKGROUND

Carbonated drinks, such as soda, are enjoyed by a wide variety of consumers. When the beverage is obtained in a restaurant, a soda fountain dispenser is often used instead of single serving cans. Within the soda fountain dispenser different techniques can be used to add CO2 gas to the liquid. One current practice is to disperse the liquid into small droplets and spray these droplets into a gas environment. The CO2 gas is then absorbed into the liquid to carbonate the beverage.

### SUMMARY

Adding CO2 using a water droplet dispersing system is limited to a single set CO2 level. These systems do not allow for a varying and controllable amount of CO2 to be added to the beverage. Their main advantage is cost—they are inexpensive.

Liquid-gas contactors, such as those sold under the Liqui-Cel™ brand name, can be used to enable precise control of the entrained amount of carbon dioxide in the liquid beverage and to readily adjust the amount of CO2 added to the beverage. Manufacturers are becoming more consciousness of their beverage quality and want a beverage, such as soda, to have the same amount of entrained carbon dioxide whether provided in single serving containers from them or when obtained from a typical soda fountain in a restaurant. The current CO2 water drop method often cannot obtain the same level of CO2 as provided by the manufacturer when soda is packaged in a bottle or can. Additionally, different sodas are prescribed to have different levels of carbon dioxide by their manufacturer when they are packaged in bottles or cans. Current soda fountain dispensers can only provide the same level of carbon dioxide irrespective of the flavor or brand of soda being dispensed. Therefore, what is needed is a carbon dioxide entrainment system that can precisely control the level of entrained carbon dioxide and can be readily changed to provide different carbon dioxide levels when dispensing different brands or flavors of soda.

When using a liquid-gas contactor to add CO2 to a liquid, the entrained gas level of CO2 can be easily changed. The CO2 level is controlled by gas diffusing directly into the liquid during transport thru a porous hollow fiber membrane. The pore size in the porous hollow fiber membrane is selected such that the liquid does not pass through the membrane wall.

In one embodiment when using a liquid-gas contactor to add CO2 to a liquid, the gas side pressure of the contactor is set at or below the liquid side pressure of the contactor to prevent the introduction of large gas bubbles into the liquid. Therefore, the contactor is preferably operated with the CO2 gas supply pressure equal to or lower than the lowest supply line water pressure that can occur. When soda is dispensed, the supply line water pressure can plummet significantly limiting the allowable CO2 gas supply pressure, which then reduces the maximum CO2 level in the liquid. Varying supply line water pressure is often a problem for obtaining a consistent level of CO2 in the dispensed soda.

The inventors found a solution to the varying supply line water pressure problem by adding a gas over liquid accumulator to the water supply for the contactor. The accumulator provides a consistent supply line pressure to the contactor; even during dispensing of the soda. The accumulator also enables the water supply pressure to the contactor to be significantly increased over the nominal water supply line pressure of municipalities. This enables the use of significantly higher CO2 gas pressures to the gas side of the contactor enabling higher levels of entrained CO2 in the carbonated beverage. Using a gas over liquid accumulator boosts the water supply line pressure without the need for a booster pump resulting in a more economical system.

To readily change and adjust the entrained CO2 level in the beverage, a variable pressure regulator can be used to adjust the pressure of the CO2 supplied to the contactor. To dispense sodas with different levels of CO2, multiple contactors can be supplied liquid from a common supply accumulator with each one fed CO2 gas at a different pressure. Alternatively, an electronically controlled pressure regulator can be used to adjust the supply gas pressure in response to the user's beverage selection.

### BRIEF DESCRIPTION OF THE DRAWINGS

FIG. 1 illustrates one embodiment of the system.

FIG. 2 illustrates a second embodiment of the system.

FIG. 3 illustrates a third embodiment of the system.

FIG. 4 illustrates a fourth embodiment of the system.

FIG. 5 illustrates a graph of dissolved CO2 in ppm versus the CO2 inlet pressure of the contactor for the system as tested in Example 1.

FIG. 6 illustrates the CO2 transfer efficiency versus run time for the system as tested in Example 2.

### DETAILED DESCRIPTION

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less. The term “substantially free of” can mean having a trivial amount of, such that a composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

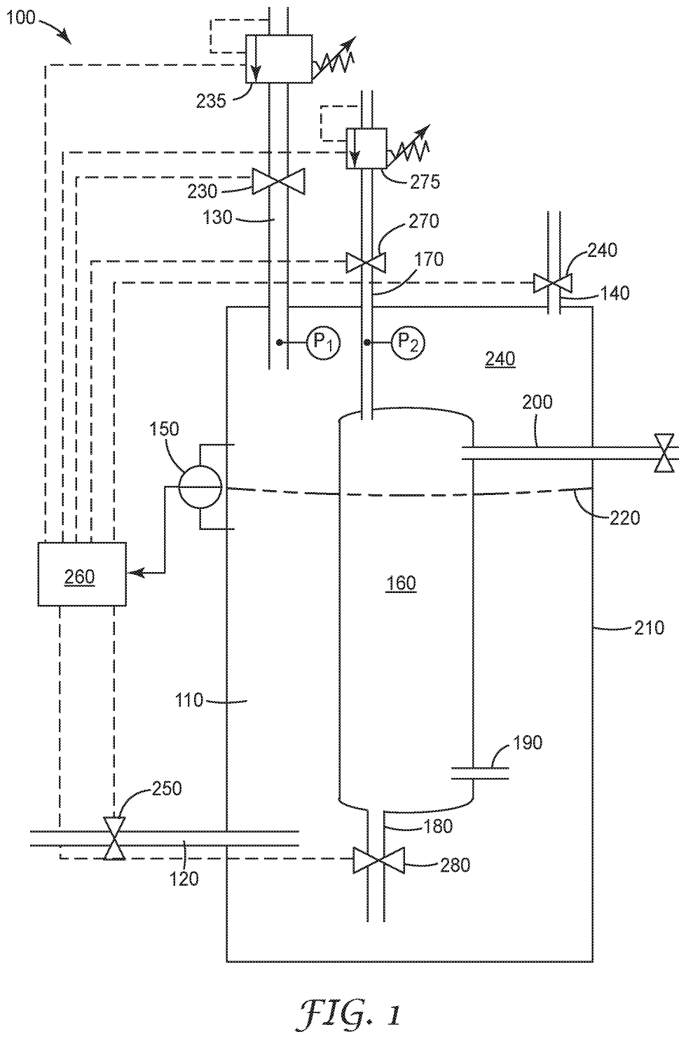

Referring now to FIG. 1, a gas entrainment system for liquids 100 is shown. The system includes an accumulator 110 having a supply water inlet 120 below the water height, a gas supply inlet 130 to the headspace above the water level, a vent 140 in the headspace, and an optional liquid level sensor 150 to monitor the water height. The accumulator is a gas over water accumulator having a pressure rated housing that contains a liquid such as water. A liquid-gas contactor 160 is located inside of the accumulator 110. The contactor includes a bundle of hollow fiber porous membranes inside the housing and a gas supply inlet 170 on one end, a gas supply outlet 180 on the opposite end, a liquid inlet 190 on one end and a liquid outlet 200 on the opposite end. While the configuration may be reversed, the gas is typically supplied to and flows through the lumens of the hollow fibers and the liquid is fed into the housing's interior chamber containing the hollow fibers and flows over their exterior surfaces. The cylindrical outer housing and headers on each end having the various fluid ports keep the gas and liquid flows separated such that gas transfer occurs only through the wall of the hollow fiber membrane. The gas supply inlet 170 and the liquid outlet 200 both the extend through a wall 210 of the accumulator. The liquid inlet 190 is disposed below a height 220 of the water in the accumulator and the contactor gas outlet 180 vents into the accumulator (although it could be extended and vented outside of the accumulator).

In this embodiment, five valves are used to control the system. Valve 1, labeled 230, is connected to a compressed gas source such as CO2 and is used to apply a variable pressure, P1, to a headspace 240 above the water level in the accumulator 110. The gas pressure raises the pressure P1 inside the accumulator and increases the water pressure fed to the contactor's inlet 190. Valve 2, labeled 240, is a pressure vent to atmosphere that is opened when filling the accumulator 100 with water to reduce or eliminate pressure inside the accumulator such that it is less than the incoming water supply line pressure. Valve 3, labeled 250, is connected to a water supply and is used to fill the accumulator with water to the operating height 220 of the water inside. Valves 1, 2, and 3 may be simple quarter turn ball valves that are manually operated or they may be solenoid operated and controlled by a controller using feedback from the liquid level sensor 150 to automatically maintain a constant height 220 for the water level in the accumulator. In some embodiments, Valve 3 (250) may be a simple check valve that will fill the accumulator as Valve 2 (240) is vented. In some embodiments, a pressure regulator 235 may be located upstream of Valve 1 (230) to maintain a constant pressure P1 in the headspace 240. Valve 1 (230) is then used to isolate the pressure regulator when venting the accumulator through Valve 2 (240).

Valve 4, labeled as 270, is connected to a pressurized gas source such as CO2 and is used to apply a variable pressure, P2, to the gas inlet 170 of the contactor. In some embodiments, a pressure regulator 275 may be located upstream of Valve 4 to maintain a constant pressure P2 to the contactor's gas inlet 170. Valve 5, labeled as 280, is a pressure vent that can be opened in some embodiments to vent the gas outlet 180 of the contactor. The contactor 160 can be operated in a “dead-head” mode or in a sweep gas mode. While manual valves can be used for all positions, it can be an advantage for the valves and the pressure regulators to be electronically controlled and operated by a controller 260 to readily adjust the entrained level of carbonation at the liquid outlet 200 as shown in FIG. 1.

In this embodiment, the contactor 160 is disposed inside the accumulator 110. The water level inside the accumulator can function as a thermal bath and can control the temperature of the liquid-gas contactor. Reducing the liquid temperature will increase gas diffusion and gas concentration at the contactor's liquid outlet 200. Suitable refrigeration systems can be employed to chill the liquid inside the accumulator and maintain it at a set temperature.

This configuration also has the contactor's gas outlet 180 venting into the accumulator. In one embodiment, the contactor is operated in a dead-end mode and occasionally the gas outlet 180 is vented to increase operational efficiency as will be described later. Venting into the accumulator provides an easy means to vent the contactor into a closed environment and can be used to help pressurize the interior of the accumulator to the desired P1 pressure of the headspace.

The accumulator is filled from a water supply by opening Valve 3 (250) and venting the headspace through open Valve 2 (240). Valve 1 (230) is closed during this operation. After the water has reached the operating height H, Valves 2 and 3 (240, 250) are closed. The accumulator is pressurized by opening Valve 1 (230) and establishing a pressure head P1 that is typically higher than the water supply pressure. As mentioned, an upstream pressure regulator 235 from Valve 1 may be used to maintain a fixed P1 pressure in the headspace. Liquid then enters the contactor liquid inlet 190 at the bottom where it is submerged in the water, passes through the contactor's interior, and then exits the contactor's liquid outlet 200 near the top of the contactor. The liquid contacts the exterior surfaces of the bundle of porous hollow fiber membranes and the liquid is subjected to gas diffusion when in contact with the hollow fibers because of the pressurized CO2 supplied to the interior of the hollow fibers. The diffusion is governed by Henry's law and is pressure and temperature dependent. Product liquid is entrained with CO2 gas and will exit the contactor at 200 and can be supplied to a dispensing valve (not shown) or soda fountain to be mixed with a soda syrup concentrate.

Changing the pressure on the contactor gas side at gas inlet 170 will change the dissolved CO2 concentration in the product liquid. As mentioned, an upstream variable pressure regulator 275 from Valve 4 (270) may be used to adjust the pressure P2 at the contactor's gas inlet 170. Specific target gas concentrations in the product are achieved by setting the contactor gas side pressure to target values.

Valve 5 (280) is used to exhaust the contactor's gas side. Because the hollow fibers are porous, Henry's Law will also cause any dissolved gases from the supply liquid, such as oxygen, to be transported into the lumens of the hollow fibers. This can reduce the apparent efficiency of the contactor to supply the desired entrained gas into the liquid. Liquid vapor may also transport across the hollow fiber membranes to the gas side. If the contactor gas side is continuously exhausting with Valve 5 (280) open (sweep mode), the transporting gases and liquid vapor will not accumulate. In this mode, the gas outlet 180 would be extended through the wall 210 of the accumulator to vent into the atmosphere. If the contactor is not continuously vented (dead-head mode), the undesirable gases and liquid vapor will establish an equilibrium concentration in the pressurized gas side of the contactor. This reduces the total concentration of the product gas in the contactor's gas side and will reduce the dissolved gas in the product liquid. One way to eliminate or reduce this problem is to use intermittent exhausting (burping) of the contactor's gas outlet 180 by briefly and intermittently opening Valve 5 (280). Opening Valve 5 (280) vents the built-up gas into the accumulator, and operating Valve 5 (280) on an intermittent schedule will prevent the undesirable gas build up. To prevent liquid backflow into the contactor's gas side, Valve 5 (280) is opened when the head space pressure P1 is lower than the supply gas pressure P2 to the contactor. Valve 2 (240) or a lower set point on pressure regulator 235 can be used reduce the head space pressure P1 if required.

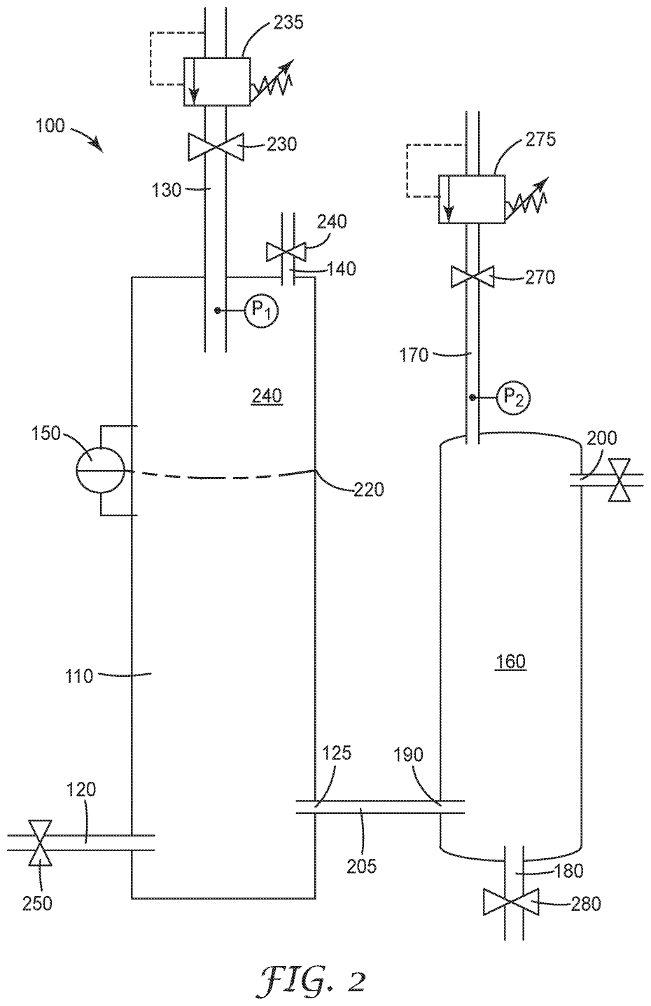

Referring now to FIG. 2, a gas entrainment system for liquids 100 is shown. The system includes an accumulator 110 having a supply water inlet 120 below the water level, a water supply outlet 125 below the water level, a gas supply inlet 130 to the headspace above the water level, a vent 140 to atmosphere in the headspace, and an optional liquid level sensor 150 to monitor the water level height. The accumulator is a gas over water accumulator having a pressure rated housing that contains a liquid such as water.

In this embodiment, the liquid-gas contactor 160 is not located inside of the accumulator 110. A pipe 205 connects the water outlet 125 of the accumulator to the water inlet 190 of the contactor. The contactor includes a bundle of hollow fiber porous membranes inside the housing and a gas supply inlet 170 on one end, a gas supply outlet 180 on the opposite end, a liquid inlet 190 on one end and a liquid outlet 200 on the opposite end. While the configuration may be reversed, the gas is typically supplied to and flows through the lumens of the hollow fibers and the liquid is fed into the housing's interior chamber containing the hollow fibers and flows over their exterior surfaces. The cylindrical outer housing and headers on each end having the various fluid ports keep the gas and liquid flows separated such that gas transfer occurs only through the wall of the hollow fiber membrane. The contactor's gas outlet 180 vents into the atmosphere.

In this embodiment, five valves are used to control the system. Valve 1, labeled 230, is connected to a compressed gas source and is used to apply a variable pressure, P1, to a headspace 240 above the water height 220 in the accumulator 110. The pressure P1 raises the pressure inside the accumulator and increases the water pressure fed to the contactor's inlet 190. Valve 2, labeled 240, is a pressure vent that is opened when filling the accumulator 100 with water to reduce or eliminate pressure inside the accumulator such that it is less than the incoming water supply line pressure. Valve 3, labeled, 250 is connected to the building water supply and is used to fill the accumulator with water to the operating height 220 of the water inside. Valves 1, 2, and 3 may be simple quarter turn ball valves that are manually operated or they may be solenoid operated and controlled by a controller using feedback from the liquid level sensor 150 to automatically maintain a constant height 220 for the water level in the accumulator. In some embodiments, a pressure regulator 235 may be located upstream of Valve 1 (230) to maintain a constant pressure P1 in the headspace 240. Valve 1 (230) is then used to isolate the pressure regulator when venting the accumulator through Valve 2 (250). In some embodiments Valve 3 (250) may be a check valve.

Valve 4, labeled as 270, is connected to a pressurized gas source and is used to apply a variable pressure, P2, to the gas inlet 170 of the contactor. In some embodiments, a pressure regulator 275 may be located upstream of Valve 4 to maintain a constant pressure P2 to the contactor's gas inlet 170. Valve 5, labeled as 280, is a pressure vent that can be opened in some modes to vent the gas outlet 180 of the contactor. The contactor 160 can be operated in a “dead-end” mode or in a sweep gas mode. While manual valves can be used for all positions, all the valves and the pressure regulators can be electronically controlled and operated by the controller 260 as shown in FIG. 1 to maintain a set level of carbonation in the liquid outlet 200.

The accumulator is filled from a water supply by opening Valve 3 (250) and venting the headspace through open Valve 2 (240). Valve 1 (230) is closed during this operation. After the water has reached the operating height H, Valves 2 and 3 (240, 250) are closed. The accumulator is pressurized by opening Valve 1 (230) and establishing a pressure head P1 that is typically higher than the water supply pressure. As mentioned, an upstream pressure regulator 235 from Valve 1 (230) may be used to maintain the P1 pressure in the headspace. Liquid then enters the contactor liquid inlet 190 and passes through the contactor's interior, and then exits the contactor liquid outlet 200 near the top of the contactor. The liquid contacts the exterior surfaces of the bundle of porous hollow fiber membranes and the liquid is subjected to gas diffusion when in contact with the hollow fibers because of the pressurized CO2 supplied to the interior of the hollow fibers. The diffusion is governed by Henry's law. When the contactor gas side is pressurized, CO2 gas will transport through the hollow fiber membranes and diffuse into the liquid. Product liquid with dissolved gas will exit the contactor and can be supplied to a dispensing valve (not shown).

Changing the pressure on the contactor gas side will change the dissolved gas concentration in the product liquid. Valve 4 (270) is used to vary the contactor gas side pressure. As mentioned, an upstream pressure regulator 275 from Valve 4 (270) may be used to vary the pressure P2 at the contactor's gas inlet 170. Specific target gas concentrations in the product are achieved by setting the contactor gas side pressure to target values.

Valve 5 (280) is used to exhaust the contactor's gas side. Because the hollow fibers are porous, Henry's Law will also cause any dissolved gases from the supply liquid, such as oxygen, to be transported into the lumens of the hollow fibers. This can reduce the efficiency of the contactor to supply the desired entrained gas into the liquid. Liquid vapor will also transport across the hollow fiber membranes to the gas side. If the contactor gas side is continuously exhausting with Valve 5 (280) open (sweep mode), the transporting gases and liquid vapor will not accumulate; however, this can use significantly more CO2 increasing operating costs. If the contactor is non-vented (dead-head mode), the undesirable gases and liquid vapor will establish an equilibrium concentration in the pressurized gas side of the contactor. This reduces the total concentration of the product gas in the contactor's gas side and will reduce the dissolved gas in the product liquid. One way to eliminate or reduce this problem is to use intermittent exhausting (burping) of the contactor's gas outlet 180 by briefly and intermittently opening Valve 5 (280).

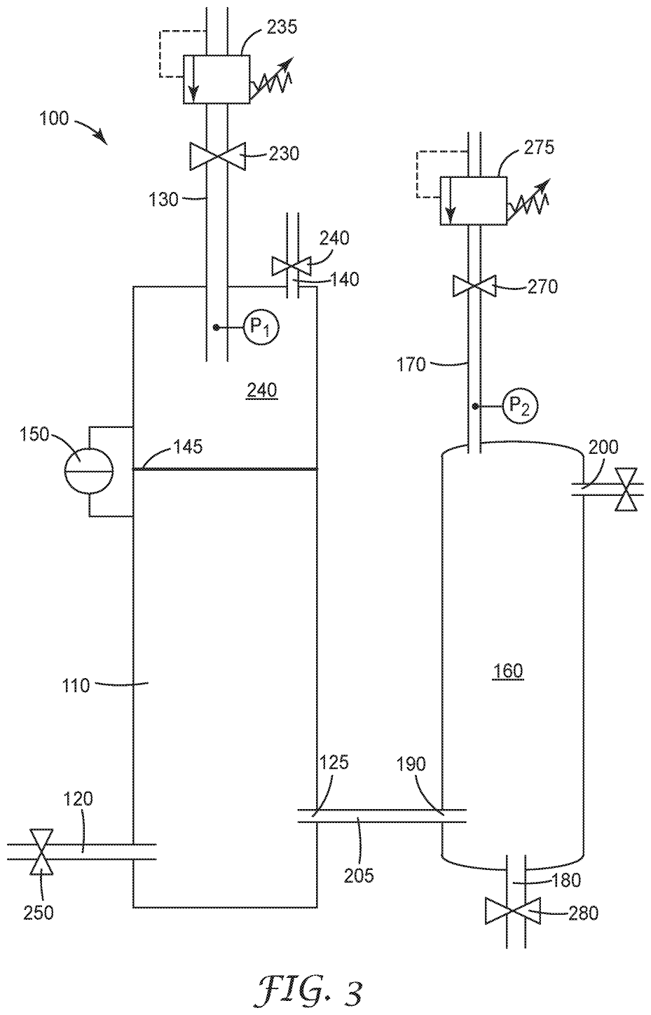

Referring now to FIG. 3, a gas entrainment system for liquids 100 is shown. The system includes an accumulator 110 having a supply water inlet 120 below the water level, a water supply outlet 125 below the water level, a gas supply inlet 130 to the headspace above the water level, a vent 140 to atmosphere in the headspace, a diaphragm or piston 145 to separate the headspace from the liquid, and an optional liquid level sensor 150 to monitor the water level height. The accumulator is a gas over water accumulator having a pressure rated housing that contains a liquid such as water. The diaphragm or piston is used to isolate the CO2 gas pressurizing the accumulator from the supply water. This configuration prevents headspace gas from diffusing into the accumulator liquid, and may reduce entrained CO2 variability in the dispensed product water due to this phenomenon.

In this embodiment, the liquid-gas contactor 160 is not located inside of the accumulator 110. A pipe 205 connects the water outlet 125 of the accumulator to the water inlet 190 of the contactor. The contactor includes a bundle of hollow fiber porous membranes inside the housing and a gas supply inlet 170 on one end, a gas supply outlet 180 on the opposite end, a liquid inlet 190 on one end and a liquid outlet 200 on the opposite end. While the configuration may be reversed, the gas is typically supplied to and flows through the lumens of the hollow fibers and the liquid is fed into the housing's interior chamber containing the hollow fibers and flows over their exterior surfaces. The cylindrical outer housing and headers on each end having the various fluid ports keep the gas and liquid flows separated such that gas transfer occurs only through the wall of the hollow fiber membrane. The contactor's gas outlet 180 vents into the atmosphere.

In this embodiment, five valves are used to control the system. Valve 1, labeled 230, is connected to a compressed gas source and is used to apply a variable pressure, P1, to a headspace 240 in the accumulator 110. The pressure P1 raises the pressure inside the accumulator and increases the water pressure fed to the contactor's inlet 190. Valve 2, labeled 240, is a pressure vent that is opened when filling the accumulator 100 with water to reduce or eliminate pressure inside the accumulator such that it is less than the incoming water supply line pressure. Valve 3, labeled, 250 is connected to the building water supply and is used to fill the accumulator with water. Valves 1, 2, and 3 may be simple quarter turn ball valves that are manually operated or they may be solenoid operated and controlled by a controller. In some embodiments Valve 3 (250) may be a check valve. In some embodiments, a pressure regulator 235 may be located upstream of Valve 1 to maintain a constant pressure P1 in the headspace 240. Valve 1 (230) is then used to isolate the pressure regulator when venting the accumulator through Valve 2 (240).

Valve 4, labeled as 270, is connected to a pressurized gas source and is used to apply a variable pressure, P2, to the gas inlet 170 of the contactor. In some embodiments, a pressure regulator 275 may be located upstream of Valve 4 (270) to vary the pressure P2 to the contactor's gas inlet 170. Valve 5, labeled as 280, is a pressure vent that can be opened in some modes to vent the gas outlet 180 of the contactor. The contactor 160 can be operated in a “dead-head” mode or in a sweep gas mode. While manual valves can be used for all positions, in some embodiments the valves and pressure regulators are electronically controlled and operated by the controller 260 as shown in FIG. 1 to easily adjust the level of carbonation in the liquid outlet 200.

The accumulator is filled from a water supply by opening Valve 3 (250) and venting the headspace through open Valve 2 (240). Valve 1 (230) is closed during this operation. After the water has reached the operating height H, Valves 2 and 3 (240, 250) are closed. The accumulator is pressurized by opening Valve 1 (230) and establishing a pressure head P1 that is typically higher than the water supply pressure. As mentioned, an upstream pressure regulator 235 from Valve 1 (230) may be used to maintain a fixed P1 pressure in the headspace. Liquid then enters the contactor liquid inlet 190 and passes through the contactor's interior, and then exits the contactor liquid outlet 200 near the top of the contactor. The liquid contacts the exterior surfaces of the bundle of porous hollow fiber membranes and the liquid is subjected to gas diffusion when in contact with the hollow fibers because of the pressurized CO2 supplied to the interior of the hollow fibers. The diffusion is governed by Henry's law. When the contactor gas side is pressurized, CO2 gas will transport through the hollow fiber membranes and diffuse into the liquid. Product liquid with dissolved gas will exit the contactor and can be supplied to a dispensing valve.

Changing the pressure on the contactor gas side will change the dissolved gas concentration in the product liquid. As mentioned, an upstream pressure regulator 275 from Valve 4 (270) may be used to vary the pressure P2 at the contactor's gas inlet 170. Specific target gas concentrations in the product are achieved by setting the contactor gas side pressure to target values.

Valve 5 (280) is used to exhaust the contactor's gas side. Because the hollow fibers are porous, Henry's Law will also cause any dissolved gases from the supply liquid, such as oxygen, to be transported into the lumens of the hollow fibers. This can reduce the efficiency of the contactor to supply the desired entrained gas into the liquid. Liquid vapor will also transport across the hollow fiber membranes to the gas side. If the contactor gas side is continuously exhausting with Valve 5 (280) open (sweep mode), the transporting gases and liquid vapor will not accumulate; however, this can use significantly more CO2 increasing operating costs. If the contactor is non-vented (dead-head mode), the undesirable gases and liquid vapor will establish an equilibrium concentration in the pressurized gas side of the contactor. This reduces the total concentration of the product gas in the contactor's gas side and will reduce the dissolved gas in the product liquid. One way to eliminate or reduce this problem is to use intermittent exhausting (burping) of the contactor's gas outlet 180 by briefly and intermittently opening Valve 5 (280).

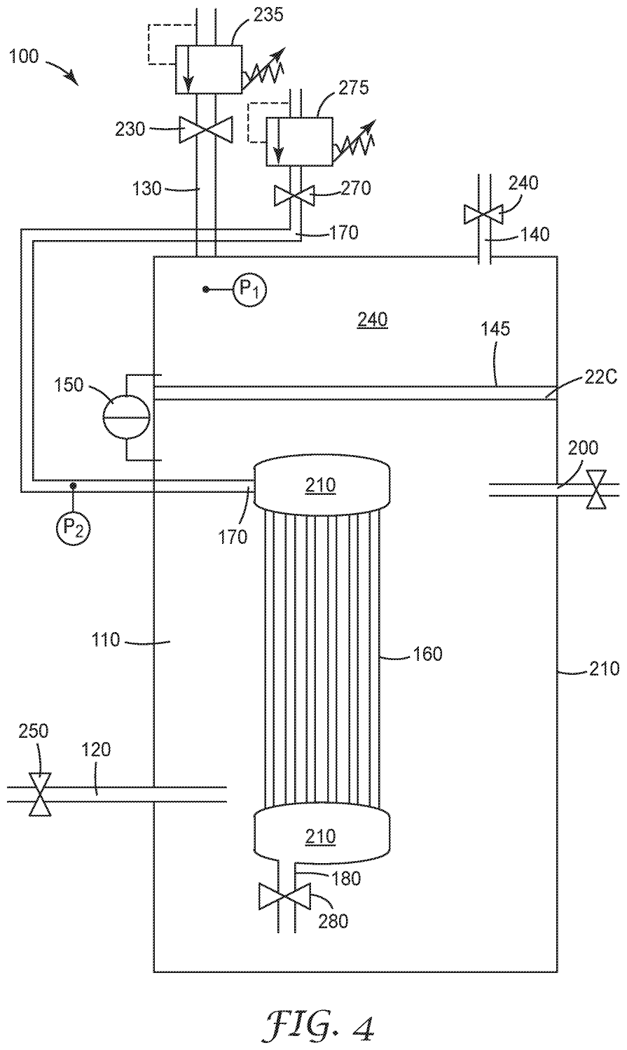

Referring now to FIG. 4, a gas entrainment system for liquids 100 is shown. The system includes an accumulator 110 having a supply water inlet 120 below the water level, a gas supply inlet 130 to the headspace 240 above the water level, a vent 140 to atmosphere in the headspace, a diaphragm or piston 145 to separate the headspace from the liquid, and an optional liquid level sensor 150 to monitor the water level height and a liquid outlet 200 below the water level 220. The accumulator is a gas over water accumulator having a pressure rated housing that contains a liquid such as water. The diaphragm or piston is used to isolate the CO2 gas pressurizing the accumulator from the supply water. This configuration prevents headspace gas from diffusing into the accumulator liquid, and may reduce entrained CO2 variability in the dispensed product water due to this phenomenon.

The contactor 160 includes a bundle of hollow fiber porous membranes a gas supply inlet 170 on one end and a gas supply outlet 180 on the opposite end and headers 210 which contain the ports and route the CO2 gas to the interior of the hollow fibers while sealing them from the liquid in the accumulator. In this configuration, the outer housing of the contactor has been eliminated such that the bundle of hollow fibers is submerged and directly exposed to the water beneath the water operating height 220, which eliminates the need for the liquid inlet 190 and liquid outlet 200 of the contactor. The CO2 gas is supplied to and flows through the lumens of the hollow fibers and the liquid in the accumulator is in contact with the hollow fibers and flows over their exterior surfaces as the liquid is dispensed from the liquid outlet 200. The contactor's gas outlet 180 vents into the accumulator or can be extended to vent to the atmosphere.

Because the contactor no longer has an exterior housing, the entire volume of the liquid in the accumulator below 220 is under goes carbonation and becomes the product water flowing out the liquid outlet 200. As such, it may be desirable to size the accumulator volume smaller such that an equilibrium entrained gas level is reached sooner. Also, it may be desirable to add mixing, stirring, a recirculation line, or other means for circulating the water in the accumulator past the hollow membranes in the accumulator.

In this embodiment, five valves are used to control the system. Valve 1, labeled 230, is connected to a compressed gas source and is used to apply a variable pressure, P1, to a headspace 240 above the water level in the accumulator 110. The pressure P1 raises the pressure inside the accumulator and increases the water pressure fed to the contactor's inlet 190. Valve 2, labeled 240, is a pressure vent that is opened when filling the accumulator 100 with water to reduce or eliminate pressure inside the accumulator such that it is less than the incoming water supply line pressure. Valve 3, labeled, 250 is connected to the building water supply and is used to fill the accumulator with water to the operating height 220 of the water inside. Valves 1, 2, and 3 may be simple quarter turn ball valves that are manually operated or they may be solenoid operated and controlled by a controller using feedback from the liquid level sensor 150 to automatically maintain a constant height 220 for the water level in the accumulator. In some embodiments, Valve 3 (250) may be a check valve for filling operations. In some embodiments, a pressure regulator 235 may be located upstream of Valve 1 (230) to maintain a constant pressure P1 in the headspace 240. Valve 1 (230) is then used to isolate the pressure regulator when venting the accumulator through Valve 2 (240).

Valve 4, labeled as 270, is connected to a pressurized gas source and is used to apply a variable pressure, P2, to the gas inlet 170 of the contactor. In some embodiments, a pressure regulator 275 may be located upstream of Valve 4 (270) to vary the pressure P2 to the contactor's gas inlet 170. Valve 5, labeled as 280, is a pressure vent that can be opened in some modes to vent the gas outlet 180 of the contactor. The contactor 160 can be operated in a “dead-head” mode or in a sweep gas mode. While manual valves can be used for all positions, in some embodiments the valves and pressure regulators are electronically controlled and operated by the controller 260 to vary the level of carbonation in the liquid outlet 200.

In this embodiment, the contactor 160 is disposed inside the accumulator 110. The water level inside the accumulator can function as a thermal bath and can control the temperature of the liquid-gas contactor. Reducing the liquid temperature will increase the dissolved gas concentration at the liquid outlet 200. Suitable refrigeration systems can be employed to chill the liquid inside the accumulator and maintain it at a set temperature.

This configuration also has the contactor gas outlet 180 venting into the accumulator. The contactor is generally operated in a dead-head mode and occasionally vented to increase operational efficiency. Venting into the accumulator provides an easy means to vent the contactor into a closed environment and can be used to help pressurize the interior of the accumulator to the desired P1 pressure of the headspace.

The accumulator is filled from a water supply by opening Valve 3 (250) (or using a check valve) and venting the headspace through open Valve 2 (240). Valve 1 (230) is closed during this operation. After the water has reached the operating height H, Valves 2 and 3 (240, 250) are closed. The accumulator is pressurized by opening Valve 1 and establishing a pressure head P1 that is typically higher than the water supply pressure. As mentioned, an upstream pressure regulator 235 from Valve 1 (230) may be used to maintain a fixed P1 pressure in the headspace. The liquid contacts the exterior surfaces of the bundle of porous hollow fiber membranes and the liquid is subjected to gas diffusion when in contact with the hollow fibers because of the pressurized CO2 supplied to the interior of the hollow fibers. Liquid exits the accumulator from liquid outlet 200. The diffusion is governed by Henry's law. When the contactor gas side is pressurized, CO2 gas will transport through the hollow fiber membranes and diffuse into the liquid. Product liquid with dissolved gas will exit the contactor and can be supplied to a dispensing valve.

Changing the pressure on the contactor gas side will change the dissolved gas concentration in the product liquid. Valve 4 (270) is used to vary the contactor gas side pressure. As mentioned, an upstream pressure regulator 275 from Valve 4 (270) may be used to vary the contactor gas side pressure P2 at the contactor's gas inlet 170. Specific target gas concentrations in the product are achieved by setting the contactor gas side pressure to target values.

Valve 5 (280) is used to exhaust the contactor's gas side. Because the hollow fibers are porous, Henry's Law will also cause any dissolved gases from the supply liquid, such as oxygen, to be transported into the lumens of the hollow fibers. This can reduce the efficiency of the contactor to supply the desired entrained gas into the liquid. Liquid vapor will also transport across the hollow fiber membranes to the gas side. If the contactor gas side is continuously exhausting with Valve 5 (280) open (sweep mode), the transporting gases and liquid vapor will not accumulate. In this mode, the gas outlet 180 would be extended through the wall 220 of the accumulator to vent into the atmosphere. If the contactor is non-vented (dead-head mode), the undesirable gases and liquid vapor will establish an equilibrium concentration in the pressurized gas side of the contactor. This reduces the total concentration of the product gas in the contactor's gas side and will reduce the dissolved gas in the product liquid. One way to eliminate or reduce this problem is to use intermittent exhausting (burping) of the contactor's gas outlet 180 by briefly and intermittently opening Valve 5 (280). Opening Valve 5 (280) vents the built-up gas into the accumulator, and operating the valve on an intermittent schedule will prevent the undesirable gas build up. To prevent liquid backflow into the contactor's gas side, Valve 5 (280) is opened when the head space pressure P1 is lower than the supply gas pressure P2 to the contactor. Valve 2 (240) or a pressure regulator can be used reduce the head space pressure P1 if required.

In the various embodiments of the figures, suitable valves and pressure regulators include: manual valves and pressure regulators, AC/DC operated solenoid valves, motorized ball valves, electronic pressure regulators, and a Parker PAR 15 series, programmable air regulating valves.

In the various embodiments of the figures, a suitable accumulator and contractor include: approximately 1-8 liter accumulators or larger (either with an internal membrane or piston or without) made by various manufacturers and a 3M LiquiCel™ MiniModule™ G800 contactor made by 3M.

In the various embodiments of the figures, suitable controllers include: a programmable logic controller, a computer, or a dedicated logic circuit on a circuit board.

In the various embodiments of the figures, the head space pressure, P1, is from 30 to 150 psi, or from 40 to 100 psi, or from 45 to 80 psi, or from 50 to 60 psi. In the various embodiments, the contactor supply gas pressure, P2, is from 20 to 145 psi, or from 25 to 135 psi, or from 30 to 125 psi, or from 35 to 110 psi. In the various embodiments, the liquid supply temperature to the contactor is from 33 to 90 degrees Fahrenheit, or from 33 to 60 degrees Fahrenheit, or from 33 to 38 degrees Fahrenheit. In the various embodiments, the liquid flow rate through the contactor is from 0.5 to about 10.5 oz/sec, or from 0.8 to 8 oz/sec, or from 1 to 4 oz/sec. In the various embodiments, the venting of Value 5 at the contactor exhaust is done for 5 to 10 seconds every 2, 4, 6, or 8 hours. In the various embodiments, the dissolved gas concentration at the contactor's outlet 200 is from 1000 to 15,000 ppm, or from 2,000 to 13,000 ppm, or from 3000 to 11,000 ppm.

The above system is not limited to dissolving CO2 into water. Other gases may be dissolved into other liquids—either hot or cold. For example, nitrogen may be dissolved into coffee.

### SELECT EMBODIMENTS OF THE PRESENT DISCLOSURE

Embodiment 1. A system for adding a gas to a liquid comprising:
a gas over liquid accumulator having an interior volume with a headspace, a liquid level, an accumulator liquid inlet, an accumulator gas inlet, and an accumulator gas outlet connected to the headspace.
a contactor having a contactor gas inlet and a contactor gas outlet;
a first supply of gas connected to the accumulator gas inlet;
a second supply of gas connected to the contactor gas inlet;
a supply of liquid connected to the accumulator liquid inlet; and
a first valve disposed between the first supply of gas and the accumulator gas inlet, a second valve connected to the accumulator gas outlet, a third valve disposed between the supply of liquid and the accumulator liquid inlet, a fourth valve disposed between the contactor gas inlet and the second supply of gas; and a fifth valve connected to the contactor gas outlet.

Embodiment 2. The system of embodiment 1 wherein the contactor is in the interior volume of the accumulator.

Embodiment 3. The system of embodiment 2 wherein the contactor comprises a bundle of hollow fiber porous membranes located inside of a housing having the contactor gas supply inlet, the contactor gas supply outlet, a contactor liquid inlet submerged below the liquid level and a contactor liquid outlet.

Embodiment 4. The system of embodiment 2 wherein the contactor comprises a bundle of hollow fiber porous membranes and does not have an outer housing such that the bundle of hollow fiber porous membranes are submerged below the liquid level and are exposed to the liquid in the interior volume.

Embodiment 5. The system of embodiments 1, 2, 3, or 4 comprising a diaphragm or piston located in the interior volume separating the headspace from the liquid level.

Embodiment 6. The system of any proceeding embodiment wherein the contactor gas outlet is vented into the interior volume.

Embodiment 7. The system of any proceeding embodiment wherein the contactor gas outlet is vented into the atmosphere.

Embodiment 8. The system of any proceeding embodiment comprising a liquid level sensor sending a signal to a controller and the controller electronically actuating the first, second, third, fourth, and fifth valves.

Embodiment 9. The system of any proceeding embodiment comprising a first pressure regulator located between the first supply of gas and the first valve and a second pressure regulator located between the second supply of gas and the fourth valve.

Embodiment 10. The system of embodiment 9 comprising a liquid level sensor sending a signal to a controller and the controller electronically actuating the first, second, third, fourth, and fifth valves, the first pressure regulator and the second pressure regulator.

Embodiment 11. The system of claim 1 wherein the gas over liquid accumulator comprises an accumulator liquid outlet and the contactor comprises a bundle of hollow fiber porous membranes located inside of a housing having the contactor gas supply inlet, the contactor gas supply outlet, a contactor liquid inlet connected to the accumulator liquid outlet and a contactor liquid outlet.

Embodiment 12. The system of embodiment 11 comprising a diaphragm or piston located in the interior volume separating the headspace from the liquid level.

Embodiment 13. The system of embodiments 11 or 12 wherein the contactor gas outlet is vented into the interior volume.

Embodiment 14. The system of embodiments 11 or 12 wherein the contactor gas outlet is vented into the atmosphere.

Embodiment 15. The system of embodiments 11, 12, 13, or 14 comprising a liquid level sensor sending a signal to a controller and the controller electronically actuating the first, second, third, fourth, and fifth valves.

Embodiment 16. The system of embodiments 11, 12, 13, 14, and 15 comprising a first pressure regulator located between the first supply of gas and the first valve and a second pressure regulator located between the second supply of gas and the fourth valve.

Embodiment 17. The system of embodiment 16 comprising a liquid level sensor sending a signal to a controller and the controller electronically actuating the first, second, third, fourth, and fifth valves, the first pressure regulator and the second pressure regulator.

Embodiment 18. A method of adding a gas to a liquid beverage comprising:
providing a gas over liquid accumulator with a first supply of gas connected to an accumulator gas inlet;
providing a contactor having a bundle of hollow fiber porous membranes, the contactor having a second supply of gas connected to the lumens of the hollow fiber membranes;
raising the pressure inside the accumulator with the first supply of gas to a pressure P1 between 30 to 150 psi;
contacting an outer surface of the bundle of hollow fiber membranes with a liquid pressured to P1;
varying a pressure P2 of the second supply of gas supplied to the lumens between 20 to 145 psi; and
entraining some of the second supply of gas into the liquid to a dissolved gas concentration between 1,000 to 15,000 ppm.

Embodiment 19. The method of embodiment 18 wherein the contactor is operated in a dead head mode the majority of time and the P2 pressure is vented intermittently.

Embodiment 20. The system of embodiment 19 wherein the contactor is vented into an interior volume of the accumulator.

### EXAMPLES

Objects and advantages of this disclosure are further illustrated by the following non-limiting examples. Particular materials and amounts thereof recited in these examples, however, as well as other conditions and details, should not be construed to unduly limit this disclosure.

### Example 1

A series of tests were completed to change the product CO2 concentration by changing the contactor CO2 gas pressure. A water reservoir with a variable line pressure was processed through a 3M Liqui-Cel™ contactor (ExtraFlow 4X13, X40 membrane, 5.4 m2 membrane surface area) to diffuse CO2 gas into the water at three different flow rates (3, 7, 10 gal/min). The supply water was at 70 psig pressure and chilled to 3 degrees Centigrade.

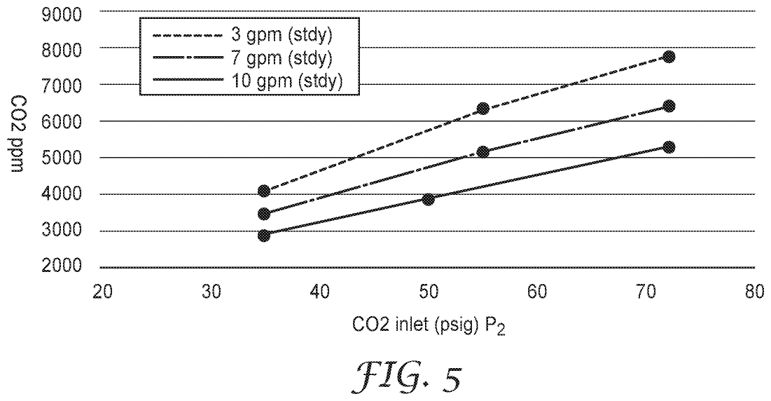

The results of the testing are summarized in FIG. 5. For a specific water flow rate, the product CO2 concentration (y axis response) is changed by controlling the contactor CO2 gas side pressure (x axis input). CO2 concentrations of 3000-8000 ppm were observed when using CO2 gas input pressures of 35-75 psig.

As seen in FIG. 1, a 70 psig water pressure is established in the accumulator by controlling the CO2 supplied through Valve 1. A pressure regulator can be set at 70 psig, and increased or decreased as desired. Carbonated water flow is driven from the accumulator by this headspace gas pressure and occurs when a downstream (point of use—POU) dispense valve is activated in the liquid outlet line 200. Product water with a specific level of dissolved CO2 gas is generated in the contactor. As the water passes through the liquid/gas contactor it contacts the hollow fiber membrane surface. CO2 is transported thru the hollow fiber membrane from the contactor gas side to the liquid side. The CO2 is diffused into the product water per the principles of Henry's law. The level of diffused CO2 in the product water is determined by the contactor CO2 gas side pressure at Valve 4. The product water exiting the contactor has a specific CO2 concentration and is ready for POU mixing dispense.

During operation, the water in the accumulator is depleted and must be refilled intermittently. This is accomplished by closing Valve 1, opening Valve 2 to vent the head space and reduce the pressure below the water supply line pressure (e.g. 40 psig), opening Valve 3 to refill the reservoir with the supply line H2O (e.g. 40 psig), closing Valve 3, and opening Valve 1 to reestablish the 70 psig head pressure. To provide a consistent liquid flow for dispensing, the liquid volume of the accumulator is sized large enough to meet the target demand without the need for refilling during beverage dispense.

### Example 2

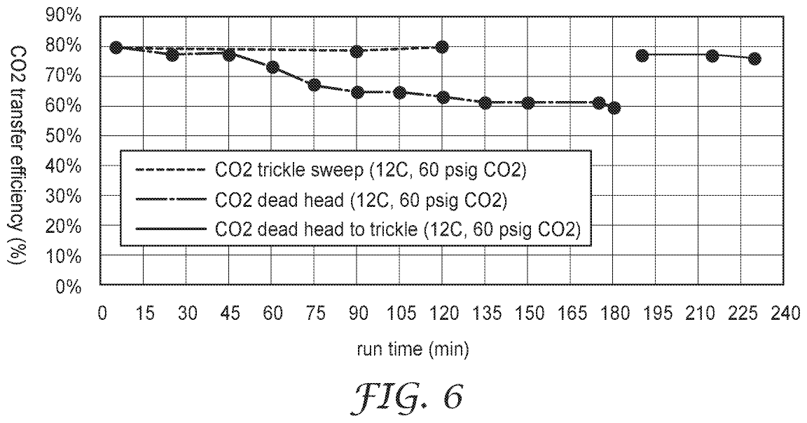

A test was completed to demonstrate operating the contactor gas side in sweep mode versus deadhead mode. During operation, gases are transported thru the permeable hollow fiber membrane in the contactor because of partial pressure differences. Gas will transport from the gas side to the liquid side, but dissolved gases from the liquid side will also transport to the gas side. If allowed to reach equilibrium, the dissolved liquid gases transported to the contactor gas side will reduce the partial pressure of the other gases present. Operating the contactor with the gas side in sweep mode (exhausting) prevents the buildup of these gases. The dissolved gas concentration and observed transfer efficiency is higher because dissolved gases leaving the liquid side and transferring to the gas side will not build up, reach an equilibrium, and reduce the concentration of other gases present. The CO2 partial pressure in the contactor gas side is maximized and the observed product CO2 concentration is higher. The calculated transfer efficiency for the process conditions (T and P specific) will be higher. An alternate method to prevent unwanted gas build up is to intermittently vent the contactor gas side and release these gases. This will bring the gas transfer efficiency back to the higher level. If the gas side contactor is operating in dead head mode without an exhaust flow, dissolved gases in the liquid that are transferring to the contactor gas side will build up and reduce the CO2 concentration. The product CO2 will be lower as a result. The data summarized in FIG. 6 supports this observation.

1. A system for adding a gas to a liquid comprising:
a gas over liquid accumulator having an interior volume with a headspace, a liquid level, an accumulator liquid inlet, an accumulator gas inlet, and an accumulator gas outlet connected to the headspace;
a contactor having a contactor gas inlet and a contactor gas outlet;
a first supply of gas connected to the accumulator gas inlet;
a second supply of gas connected to the contactor gas inlet;
a supply of liquid connected to the accumulator liquid inlet; and
a first valve disposed between the first supply of gas and the accumulator gas inlet, a second valve connected to the accumulator gas outlet, a third valve disposed between the supply of liquid and the accumulator liquid inlet, a fourth valve disposed between the contactor gas inlet and the second supply of gas; and a fifth valve connected to the contactor gas outlet.

2. The system of claim 1 wherein the contactor is in the interior volume of the accumulator.

3. The system of claim 2 wherein the contactor comprises a bundle of hollow fiber porous membranes located inside of a housing having the contactor gas supply inlet, the contactor gas supply outlet, a contactor liquid inlet submerged below the liquid level and a contactor liquid outlet.

4. The system of claim 2 wherein the contactor comprises a bundle of hollow fiber porous membranes and does not have an outer housing such that the bundle of hollow fiber porous membranes are submerged below the liquid level and are exposed to the liquid in the interior volume.

5. The system of claim 1, comprising a diaphragm or piston located in the interior volume separating the headspace from the liquid level.

6. The system of claim 1 wherein the contactor gas outlet is vented into the interior volume.

7. The system of claim 1 wherein the contactor gas outlet is vented into the atmosphere.

8. The system of claim 1 comprising a liquid level sensor sending a signal to a controller and the controller electronically actuating the first, second, third, fourth, and fifth valves.

9. The system of claim 1 comprising a first pressure regulator located between the first supply of gas and the first valve and a second pressure regulator located between the second supply of gas and the fourth valve.

10. The system of claim 9 comprising a liquid level sensor sending a signal to a controller and the controller electronically actuating the first, second, third, fourth, and fifth valves, the first pressure regulator and the second pressure regulator.

11. The system of claim 1 wherein the gas over liquid accumulator comprises an accumulator liquid outlet and the contactor comprises a bundle of hollow fiber porous membranes located inside of a housing having the contactor gas supply inlet, the contactor gas supply outlet, a contactor liquid inlet connected to the accumulator liquid outlet and a contactor liquid outlet.

12. The system of claim 11 comprising a diaphragm or piston located in the interior volume separating the headspace from the liquid level.

13. The system of claim 11 wherein the contactor gas outlet is vented into the interior volume.

14. The system of claim 11 wherein the contactor gas outlet is vented into the atmosphere.

15. The system of claim 11, comprising a liquid level sensor sending a signal to a controller and the controller electronically actuating the first, second, third, fourth, and fifth valves.

16. The system of claim 11, comprising a first pressure regulator located between the first supply of gas and the first valve and a second pressure regulator located between the second supply of gas and the fourth valve.

17. The system of claim 16 comprising a liquid level sensor sending a signal to a controller and the controller electronically actuating the first, second, third, fourth, and fifth valves, the first pressure regulator and the second pressure regulator.

18. A method of adding a gas to a liquid beverage comprising:
providing a gas over liquid accumulator with a first supply of gas connected to an accumulator gas inlet;
providing a contactor having a bundle of hollow fiber porous membranes, the contactor having a second supply of gas connected to the lumens of the hollow fiber membranes;
raising the pressure inside the accumulator with the first supply of gas to a pressure P1 between 30 to 150 psi;
contacting an outer surface of the bundle of hollow fiber membranes with a liquid pressured to P1;
varying a pressure P2 of the second supply of gas supplied to the lumens between 20 to 145 psi; and
entraining some of the second supply of gas into the liquid to a dissolved gas concentration between 1,000 to 15,000 ppm.

19. The method of claim 18 wherein the contactor is operated in a dead head mode a majority of time and the P2 pressure is vented intermittently.

20. The system of claim 19 wherein the contactor is vented into an interior volume of the accumulator.
